(19) United States
(12) Patent Application Publication
(10) Pub. No.: US 2012/0109662 A1
(43) Pub. Date: May 3, 2012

(54) MANAGING REPLACEMENT OF AN EXISTING COMPONENT

(76) Inventors: Amip J. Shah, Santa Clara, CA (US); Priya Mahadevan, Sunnyvale, CA (US)

(21) Appl. No.: 12/913,921

(22) Filed: Oct. 28, 2010

(51) Int. Cl. G06Q 99/00

(52) U.S. Cl. 705/1.1

(57) ABSTRACT

In a method of managing replacement of at least one existing component with at least one replacement component, in which the at least one replacement component comprises a different number of components than the at least one existing component, at least one cost associated with implementing the at least one existing component is obtained. The at least one cost includes an environmental cost and a utility cost associated with implementing the at least one existing component. An existing net benefit of continuing implementation of the at least one existing component is calculated based upon the obtained at least one cost. A new net benefit of at least one of procuring and implementing the at least one replacement component is calculated.

### CROSS REFERENCE TO RELATED APPLICATIONS

The present application shares some common subject matter with PCT Application No. PCT/US08/57040, filed on Mar. 14, 2008, by Amip Shah et al.; PCT Application No. PCT/US07/85602, filed on Nov. 27, 2007, by Amip J. Shah et al.; U.S. Provisional Patent Application No. 60/990,438, filed on Nov. 27, 2007, by Amip J. Shah et al.; U.S. patent application Ser. No. 12/237,695, filed on Sep. 25, 2008, by Amip J. Shah et al.; and U.S. patent application Ser. No. 12/538,454, filed on Aug. 10, 2009, by Amip J. Shah, et al. The disclosures of which are hereby incorporated by reference in their entireties.

### BACKGROUND

The continuous evolution of technology leads to a need for frequent refreshment of old or obsolete technology. Decisions on whether to replace an apparatus for performing work are typically made based upon the direct economic cost of the replacement or when the apparatus' functionality has been lost. Thus, for instance, an apparatus is typically replaced when the acquisition costs of a new apparatus is below some user-defined budgetary threshold or when the apparatus ceases to work. The budgetary threshold used to determine when the apparatus is to be replaced may involve other factors, such as, the depreciation or amortization of the existing apparatus and the potential for activity enabled by the new apparatus. As such, the decision of whether and when to replace the apparatus is entirely user-initiated, and is often based purely on functionality.

The user-initiated decision is highly subjective and thus lacks a robust quantitative consideration. Accordingly, the timing at which apparatuses are replaced often lacks optimization and thus apparatuses are often replaced before the apparatuses have been implemented for their entire useful lifetimes or after the apparatuses have exceeded their usefulness as compared with benefits available from new apparatuses.

### BRIEF DESCRIPTION OF THE DRAWINGS

Features of the present disclosure will become apparent from the following description with reference to the figures, in which:

FIG. 1 shows a simplified block diagram of a system for automatically estimating the replacement cost for an existing component(s) that considers environmental costs and utility costs, according to an example of the present disclosure;

FIG. 2 shows a flow diagram of a method of managing replacement of at least one existing component with at least one replacement component, according to an example of the present disclosure;

FIG. 3, collectively show a flow diagram of a method of managing replacement of at least one existing component with at least one replacement component, according to another example of the present disclosure; and

FIG. 4 shows a schematic representation of a computing device 400 that may be used as a platform for implementing or executing the processes depicted in FIGS. 2 and 3, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

Disclosed herein are a method and apparatus of managing replacement of at least one existing component with at least one replacement component that includes a different number of components than the existing component(s). The existing component(s) generally comprises a component(s) that is currently being implemented, used, or otherwise being utilized. The replacement component(s) may comprise a new and/or previously existing component(s) that may replace the existing component(s). The method and apparatus is to manage the replacement based upon environmental costs and utilities associated with the existing component(s) and the replacement component(s). The environmental costs of the existing component(s) and the replacement component(s) may include at least one cost associated with exergy (or sustainability), carbon emissions, energy efficiency, etc. Thus, for instance, the environmental costs may include costs determined from a life-cycle analysis of the components.

Generally speaking, “exergy” is synonymous with “available energy” and may be defined as a measure of the amount of work a system has the ability of performing. In comparison with energy, which cannot be destroyed because it merely goes from one state to another, exergy, or available energy, is typically destroyed as the system performs work, and thus addresses both energy and material consumption. More particularly, the second law of thermodynamics necessitates the presence of irreversibilities (or entropy) in any real, physical system. These irreversibilities essentially reduce the amount of work that may be available for utilization by the system. These irreversibilities lead to destruction of available energy or resources (that is, exergy). For example, the process of converting coal into electricity is an irreversible process and the conversion, therefore, corresponds to a destruction of exergy.

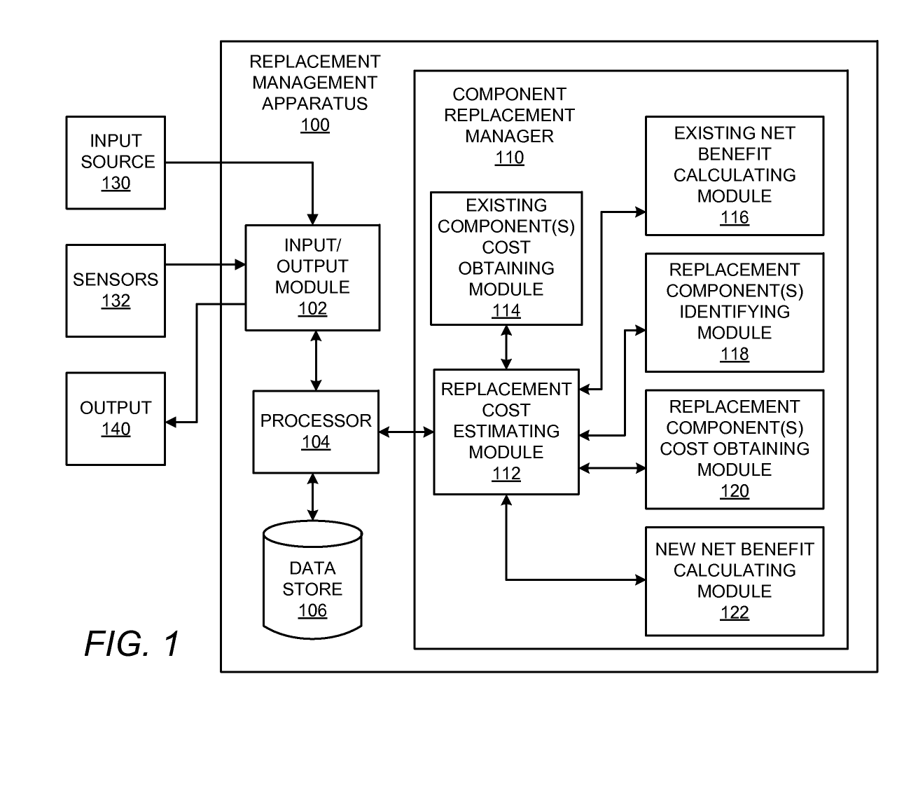

With reference first to FIG. 1, there is shown a simplified block diagram of a replacement management apparatus 100 for automatically estimating a replacement cost for at least one existing component that considers environmental costs and utility costs, according to an example. It should be understood that the apparatus 100 may include additional elements and that some of the elements described herein may be removed and/or modified without departing from the scope of the apparatus 100.

As shown in FIG. 1, the apparatus 100 includes an input/output module 102, a processor 104, a data store 106, and a component replacement manager 110. The apparatus 100 is depicted as being in communication with an input source 130, sensors 132, and an output 140. The component replacement manager 110 is depicted as including a replacement cost estimating module 112, an existing component(s) cost obtaining module 114, an existing net benefit calculating module 116, at least one replacement component identifying module 118, at least one replacement component cost obtaining module 120, and a new net benefit calculating module 122.

According to an example, the component replacement manager 110 comprises machine readable instructions stored, for instance, in a volatile or non-volatile memory, such as dynamic random access memory (DRAM), electrically erasable programmable read-only memory (EEPROM), magnetoresistive random access memory (MRAM), flash memory, floppy disk, a CD-ROM, a DVD-ROM, or other optical or magnetic media, and the like. In this example, the modules 112-122 comprise modules with machine readable instructions stored in the memory, which are executable by the processor 104. According to another example, the component replacement manager 110 comprises a hardware device, such as, a circuit or multiple circuits arranged on a board. In this example, the modules 112-122 comprise circuit components or individual circuits, which may also be controlled by the processor 104. According to a further example, the component replacement manager 110 comprises a combination of modules with machine readable instructions and hardware modules. In addition, multiple processors may be employed to implement or execute the component replacement manager 110.

The replacement management apparatus 100 may comprise a computing device and the component replacement manager 110 may comprise an integrated and/or add-on hardware device of the computing device. As another example, the component replacement manager 110 may comprise a computer readable storage device upon which machine readable instructions for each of the modules 112-122 are stored and executed by the processor 104.

Although the existing component(s) cost obtaining module 114 and the replacement component(s) cost obtaining module 118 have been depicted as forming separate components, it should be understood that a single cost obtaining module may be implemented in place of both of the existing component(s) cost obtaining module 114 and the replacement component(s) cost obtaining module 118 without departing from a scope of the manager 110. Likewise, a single net benefit calculating module may be implemented in place of both of the existing net benefit calculating module 116 and the new net benefit calculating module 120 without departing from a scope of the manager 110. In addition, although the modules 112-122 have been depicted as communicating with the replacement cost estimating module 112, some or all of the modules 114-122 may communicate directly with each other without departing from a scope of the manager 110.

The “components” discussed in the present disclosure may comprise any suitable machine readable instructions and/or apparatus that may be replaced over a course of time in which the machine readable instructions and/or apparatus is implemented. By way of example, the components may include machine readable instructions, such as, machine readable instructions used in personal and/or business environments. Other examples of suitable components include, servers, network switches, network routers, desktop computers, laptop computers, printing devices, automobiles, airplanes, trains, cellular telephones, buildings, data centers, air conditioning units, etc. Additional examples of suitable components include virtual components, which include, but are not limited to virtual components used within or to deliver a information technology (IT) service to, for instance, an end user. For example, the replacement component(s) may comprise machine readable instructions for delivering an IT service, such as web-based services or hosting virtualized clients, to a user. As a particular example, the existing component(s) may comprise at least one hardware device and the replacement component(s) may comprise machine readable instructions for enabling outsource IT services to replace the IT services performed by the at least one hardware device. Moreover, the virtual components may include artifacts, such as, but not limited to, electronic messages, software code, or other similar elements that are hosted upon physical hardware. It should thus be understood that the “components” discussed herein may encompass any of a number of different types of entities.

As described in greater detail herein below, the processor 104 is to implement or execute the component replacement manager 110 to manage, for instance, decisions on whether to replace at least one existing component with at least one replacement component, in which the at least one replacement component comprises a different number of components than the at least one existing component. In addition, the processor 104 may implement or execute the component replacement manager 110 to automatically determine whether an existing component(s) should be replaced with the replacement component(s).

In performing the methods disclosed herein, the processor 104 may receive input from the input source 130, which may comprise a computing device, a database containing various information stored on a data store, a user input source, such as, a keyboard, mouse, etc., or other source through which information may be inputted into the replacement management apparatus 100 through the input/output module 102. Thus, the input source 130 may comprise a device that is peripherally connected to the apparatus 100 or the input source 130 may be connected to the apparatus 100 through a network connection, such as, a local area network connection, a wide area network connection, the Internet, etc. Alternatively, the input source 130 may be integrated with the apparatus 100.

The input source 130 may input data pertaining to, for instance, various costs associated with implementing existing components, various costs associated with procuring and implementing replacement components, various hierarchical or other arrangements of the replacement components, useful work performed or determined to be performed by the existing and replacement components, lifetimes of the existing components, time required to procure replacement components, various weighting coefficients for aspects of the existing and replacement components, power consumption information of the existing and replacement components, costs associated with disposing existing and replacement components, etc. The costs may be defined in terms of both financial and environmental costs. The environmental costs may include environmental costs associated with life-cycle environmental costs of either or both of the existing components and the replacement components.

The replacement management apparatus 100 may also receive input from at least one sensor 132, which is configured to detect at least one condition associated with the existing and/or replacement components. The at least one condition may include, for instance, temperature, pressure, humidity, volume flow rate, etc. In addition, or alternatively, the at least one sensor 132 may be configured to detect the amount of power consumed by the existing components. Alternatively, “synthetic” sensors, such as those that determine states related to machine readable instruction implementation, the expected revenue from a particular application, or higher-order metrics related to the considered apparatus, may also be included. According to an example, the component replacement manager 110 is configured to implement the data received from the at least one sensor 132 in determining one or both of the financial and environmental costs associated with implementing the existing components, as discussed in greater detail herein below.

In any regard, the input/output module 102 is configured to receive input from the input source 130 and the sensor(s) 132. According to an example, the input/output module 102 may provide a graphical user interface through which a user may provide instructions to the replacement management apparatus 100. In addition, the input received by the input/output module 102 may be stored in the data store 106, which may comprise a combination of volatile and non-volatile memory, such as DRAM, EEPROM, MRAM, flash memory, and the like. In addition, or alternatively, the data store 106 may comprise a device configured to read from and write to a removable media, such as, a floppy disk, a CD-ROM, a DVD-ROM, or other optical or magnetic media.

The replacement cost estimating module 112 is configured to receive or obtain input data received through the input/output module 102. The replacement cost estimating module 112 also interfaces with the existing component(s) cost obtaining module 114, which obtains various cost information associated with implementing the existing component(s) that the replacement cost estimating module 112 implements in estimating a replacement cost of the existing component(s). According to an example, the replacement cost estimating module 112 is configured to calculate exergy loss values associated with continuing implementation of the existing component(s) by implementing thermodynamic properties of the existing component(s) as discussed, for instance, in PCT

The replacement cost estimating module 112 also interfaces with the existing net benefit calculating module 116, which is configured to calculate a net benefit associated with implementing the existing component(s). In calculating the existing net benefit, the existing net benefit calculating module 116 may factor at least one environmental impact cost associated with implementing the existing component(s). The replacement cost estimating module 112 may employ the existing net benefit calculated by the existing net benefit calculating module 116 in determining the replacement cost of the existing component(s).

The replacement cost estimating module 112 also interfaces with the replacement component(s) identifying module 118 and the replacement component(s) cost obtaining module 120. The replacement component(s) identifying module 118 may identify at least one replacement component that may be used to replace the at least one existing component. The replacement component(s) cost obtaining module 120 obtains various cost information associated with at least one of procuring and implementing at least one replacement component that is capable of replacing the existing component(s). The replacement cost estimating module 120 may implement the various cost information in determining whether to replace the existing component(s) with the replacement component(s). According to an example, the replacement cost estimating module 112 is configured to calculate exergy loss values associated with replacing the existing component(s) with the replacement component(s).

The replacement cost estimating module 112 also interfaces with the new net benefit calculating module 122, which may calculate a net benefit associated with at least one of procuring and implementing the replacement component(s). In calculating the new net benefit, the new net benefit calculating module 122 is configured to factor at least one environmental impact cost associated with at least one of procuring and implementing the replacement component(s). The replacement cost estimating module 112 may employ the new net benefit calculated by the new net benefit calculating module 122 in determining whether to replace the existing component(s) with the replacement component(s).

In one example, the processor 104 may output data relating to the replacement cost of the existing component(s) or a recommendation on whether to keep the existing component(s) or replace the existing component(s) with at least one replacement component to the output 140 through the input/output module 102. The output 140 may comprise, for instance, a display configured to display the outputted data, a fixed or removable storage device on which the outputted data is stored, a connection to a network over which the outputted data is communicated, etc.

According to an example, the replacement cost estimating module 112 determines, through a priori estimates, when an existing component(s) should be replaced. By way of example, a printer may employ the replacement cost estimating module 112 to determine in advance when it becomes economically or environmentally feasible to replace an ink cartridge. As another example, given a specific failure rate, the replacement cost estimating module 112 may determine in advance of an optimal time to replace a failed component, for instance, a hard disk drive in a computing device, and whether it is more economically or environmentally feasible to then replace just the failed component or the entire system. Thus, for instance, the replacement cost estimating module 112 may be configured to determine optimized useful remaining lifetimes of existing apparatuses through application of modeling techniques. In addition, the replacement cost estimating module 112 may identify replacement components that result in optimized new net benefits.

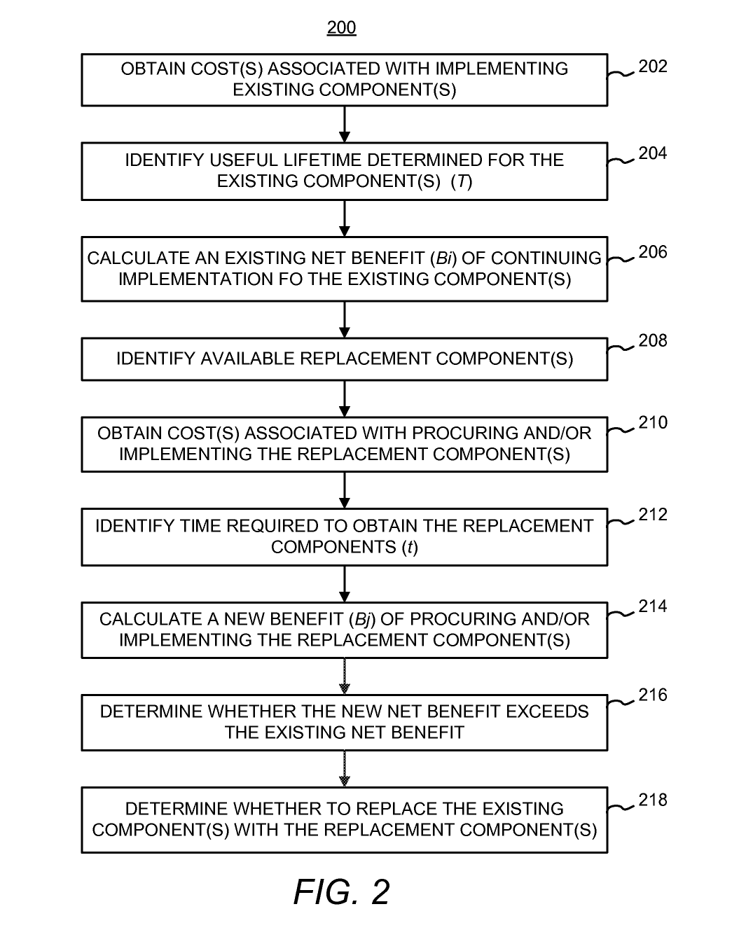

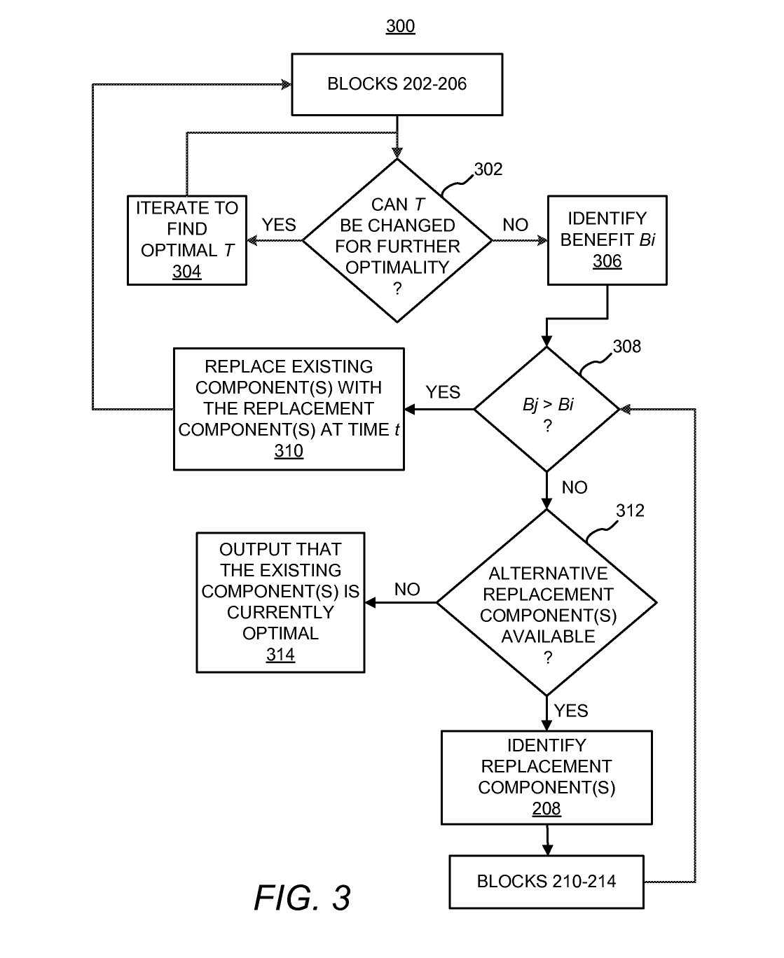

Examples of methods in which the component replacement manager 110 may be employed to manage replacement of at least one existing component with at least one replacement component, will now be described with respect to the following flow diagrams of the methods 200 and 300 depicted in FIGS. 2 and 3. It should be readily apparent that the methods 200 and 300 represent generalized illustrations and that other processes may be added or existing processes may be removed, modified or rearranged without departing from the scopes of the methods 200 and 300.

The descriptions of the methods 200 and 300 are made with reference to the replacement management apparatus 100 illustrated in FIG. 1, and thus makes reference to the elements cited therein. It should, however, be understood that the methods 200 and 300 are not limited to the elements set forth in the apparatus 100. Instead, it should be understood that the methods 200 and 300 may be practiced by a system having a different configuration than that set forth in the apparatus 100.

Generally speaking, the methods 200 and 300 may be implemented to determine whether at least one existing component should be replaced with at least one replacement component that is able to perform the functions of the existing component(s). Thus, for instance, the methods 200 and 300 may be implemented to determine whether an older and larger component should be replaced with a number of smaller, more efficient replacement components. By way of particular example in which the existing component(s) comprises networking equipment, such as, a network switch, the methods 200 and 300 may be implemented to determine whether the networking equipment should be replaced with a number of smaller, more efficient networking equipment. In this example, a structured topological arrangement, such as, a hierarchical topology, a star topology, a mesh topology, etc., of the networking equipment may also be determined and considered in the determination. The topological arrangement for the smaller number of replacement networking switches may also be determined to replace the existing networking switch in such a manner that the smaller number of replacement networking switches are connected to each other to enable the forwarding capacity of the replacement networking switches to at least be equivalent to that of the existing networking switch.

As another example, the methods 200 and 300 may be implemented to determine whether a number of existing components should be replaced with a lesser number of replacement components than the existing components. For instance, the methods 200 and 300 may be implemented to determine whether a number of older components should be replaced with a lesser number of replacement components.

With reference first to FIG. 2, at block 202, at least one cost associated with implementing the existing component(s) is obtained, for instance, by the existing component(s) cost obtaining module 114. The at least one cost includes at least one environmental cost associated with implementing the existing component(s). Examples of suitable environmental costs include, exergy, carbon emissions, energy consumption levels, energy efficiencies, etc. In addition, the existing component(s) cost obtaining module 114 may obtain the at least one cost from a database, from information contained in user inputted data, etc.

At block 204, a useful lifetime remaining until the existing component(s) is likely to stop producing useful work is identified, for instance, by the replacement cost estimating module 112. The replacement cost estimating module 112 may determine the useful lifetime remaining for the existing component(s) from information received from a user or through a determination of the useful lifetime remaining, as discussed herein below. In addition, the replacement cost estimating module 112 may identify an amount of useful work that the existing component(s) is likely to perform over a given amount of time, such as, per year. In an example of a computer system, the useful work may be measured in terms of a computational performance metric, such as the number of instructions processed per second, the total number of instructions processed per year, etc. In an example with other types of systems, similar performance metrics may be measured, such as, for a vehicle, the number of miles driven per year; for a telephone, the number of hours of talktime per year, etc.

At block 206, an existing net benefit of continuing implementation of the existing component(s) based upon the obtained at least one cost is calculated, for instance, by the existing net benefit calculating module 116. In calculating the existing net benefit, the existing net benefit calculating module 116 may calculate a total useful work that the existing component(s) is determined to have remaining in the identified useful lifetime remaining for the existing component(s). More particularly, for instance, the existing net benefit calculating module 116 may calculate the total useful work as a function of the identified useful lifetime remaining and the useful work produced by the existing component(s) over a predetermined period of time.

The function may also include a weighting coefficient that is selected as a function of operation policy. For instance, in instances where performance of the existing component(s) is determined to be the most critical, the weighting coefficient may be relatively high. In other instances where the production of useful work is determined to be not as critical, such as with non-critical workloads, the weighting coefficient may be relatively low. As other examples, the weighting coefficient may be defined as some arbitrary constant value, as a function of other dependent variables, such as, time of day, prior lifecycle history, functional criticality, etc.

By way of particular example, the total useful work (U) remaining of the existing component(s) (i) may be calculated through the following equation:

Uᵢ=Wᵢ₁×uᵢ×T. Equation (1):

In Equation (1), uᵢ is the useful work that the ith existing component(s) is determined to perform over a given period of time, T is the identified useful lifetime remaining for the ith existing component(s), and Wᵢ₁ is the weighting coefficient applied to the ith existing component(s).

In addition, the existing net benefit calculating module 116 may further calculate a cost of operation of the existing component(s) as a function of a direct operational cost of the existing component(s) (which may include, for instance, the power consumption of the existing component(s)), the identified useful lifetime remaining, and a weighting coefficient for cost. The weighting coefficient for cost may also be selected as a function of operation policy. Thus, for instance, the weighting coefficient may be relatively higher when the financial costs of operating the existing component(s) is determined to be more critical than, for example, the amount of useful work that the existing component(s) is able to perform over a given period of time.

By way of particular example, the cost (C) associated with performing the total work (Uᵢ) by the ith existing component(s) may be calculated through the following equation:

C₁=Wᵢ₂×Oᵢ×T. Equation (2):

In Equation (2), Oᵢ is the direct operational cost of the ith existing component(s) per unit time, T is the identified useful lifetime remaining for the ith existing component(s), and Wᵢ₂ is a weighting coefficient applied to the ith existing component(s). The direct operational cost (Oᵢ) of the ith existing component(s) may include, for instance, at least one of electricity costs, maintenance costs, lifetime exergy, carbon emissions, etc.

The existing net benefit calculating module 116 may further calculate the existing net benefit as a function of the calculated total useful work, the cost of operation, and a third weighting coefficient. By way of example, the existing net benefit calculating module 116 may calculate the net benefit (B1) achievable by operating the existing component(s) over its remaining lifetime may be evaluated as:

Bᵢ=f(Uᵢ, Cᵢ, W). Equation (3):

By way of particular example, the net benefit may be determined according to the following equation:

Bᵢ=(Wᵢ₁×Uᵢ)/(Wᵢ₂×Cᵢ). Equation (4):

Although the function in Equation (4) has been described as a quotient, other functions may be applied to determine the net benefit. For instance, instead of the quotient, a subtraction or multiplication may be applied. In addition, both the total useful work (Uᵢ) and the total cost (Cᵢ) may change as a function of time as the utility of the existing component(s) diminishes.

In Equations (3) and (4), W represents a weighting coefficient and may be a single- or multi-dimensional weighting matrix that may be used to bias the net benefit in terms of either utility or cost, depending on, for instance, operational policy. For instance, if performance is determined to be critical, the benefit may be weighted more towards the useful work (Uᵢ); however, if energy efficiency is determined to be critical, the benefit may be weighted more towards the cost (Cᵢ). In addition, or alternatively, the weighting coefficient W may be defined independently, as a function of operating principle, as some function of the previous weighting coefficients (Wᵢ₁, Wᵢ₂), etc. The different components of the weighting coefficient W may also be selected as a unit-dependent set of parameters, for instance, a first weighting coefficient Wᵢ₁ may be a Joules/Performance multiplier and a second weighting coefficient Wᵢ₂ may be a unitless multiplier, thus giving the existing net benefit Bᵢ in terms of Joules.

At block 208, the available replacement component(s) that may be used to replace the existing component(s) is identified, for instance, by the replacement component(s) identifying module 118. In addition to identifying the available replacement component(s), the replacement component(s) identifying module 118 may also determine the number of replacement component(s) to be used to replace the existing component(s), in which the number of replacement components to be used differs from the number of existing components. According to an example, a user may input the available replacement components into the component replacement manager 110 through the input/output module 102.

In another example, the replacement component(s) identifying module 118 may access a database, such as, a component library (not shown), that identifies compatible replacement component(s) for the existing component(s). In this example, the replacement component(s) identifying module 118 may determine a hierarchical, meshed, or other structured topological arrangement of the replacement component(s) that may be used to replace the existing component(s). By way of example in which the existing component(s) comprises networking equipment, the replacement component(s) identifying module 118 may determine that the existing component(s) may be replaced by a combination of a first tier level network switch, a second tier level network switch, a third tier level network switch, etc. In this example, the replacement component(s) identifying module 118 may determine a topological arrangement for the replacement network switches. In addition, as discussed below with respect to the method 300 in FIG. 3, alternate combinations and/or configurations of the available replacement component(s) may be analyzed to identify replacement component(s) that substantially optimizes at least one metric used in determining whether to replace the existing component(s) with the identified replacement component(s).

At block 210, at least one cost associated with at least one of procuring and implementing the replacement component(s) identified at block 208 is obtained, for instance, by the replacement component(s) cost obtaining module 118. The at least one cost includes at least one of an environmental cost associated with at least one of procuring and implementing the replacement component(s). Examples of suitable environmental costs include, exergy, carbon emissions, energy consumption levels, etc. In addition, the replacement component(s) cost obtaining module 118 may obtain the at least one cost from a database, from information contained in user inputted data, etc.

At block 212, a length of time determined to be required in obtaining the replacement component(s) is identified, for instance, by the replacement cost estimating module 112. The replacement cost estimating module 112 may identify the length of time determined to be required from information received from a user or through access to a database containing the information. The length of time determined to be required in obtaining the replacement component(s) may include, for instance, time in which the replacement component(s) will be in research and development, time in which the replacement component(s) will be in manufacturing, time to ship and install the replacement component(s), etc.

At block 214, a new net benefit of at least one of procuring and implementing the replacement component(s) is calculated, for instance, by the new net benefit calculating module 122. The new net benefit calculating module 122 may identify an amount of useful work (uⱼ) that the replacement component(s) (j) is likely to perform during a period of time between when the replacement component(s) will be available (t) and the identified length of time that the existing component(s) is determined to have remaining (T) to perform useful work. By way of example, the useful work that the replacement component(s) is likely to perform during that period of time may be calculated from the following equation:

Uᵢ=Wⱼₖ×uⱼ×(T−t). Equation (5):

In Equation (5), the Wⱼₖ represents a weighting coefficient, which may be selected in a manner similar to any of the manners discussed above with respect to the weighting coefficient Wᵢ₁. In an example of a computer system, the useful work (Uᵢ) of a replacement computer system may be measured in terms of a computational performance metric, such as the number of instructions processed per second, the total number of instructions processed per year, etc., that the replacement computer system is able to perform between the time period (T−t).

In addition, the new net benefit calculating module 122 is further configured to calculate a cost of operation of the replacement component(s) (Cj) as a function of a cost of putting the replacement component(s) into operation (Iⱼ), the direct cost of operation of the replacement component(s) per unit time (Oⱼ) the time period (T−t), and the cost of disposing the existing component(s) (Dᵢ), for instance, according to the following equation:

Cⱼ=Wⱼ₂×lⱼ+Wⱼ₃×Oⱼ×(T−t)+Wⱼ₄×Dᵢ. Equation (6):

In Equation (6), the weighting coefficients Wⱼₖ may be selected in a manner similar to any of the manners discussed above with respect to the weighting coefficient Wᵢ₁ and may thus be selected based upon desired criticalities of the different costs. Thus, for instance, the weighting coefficients may be selected as a function of operational principle, sustainability drivers, cost considerations, etc. For example, the weighting coefficient Wⱼ₃ may have a higher value if operational costs are determined to be important, Wⱼ₄ may be selected to have a higher value if the amount of recycled materials recovered from scrap is determined to be important, and Wⱼ₂ may have a higher value if the fixed costs are determined to be important.

In addition, the cost of putting the replacement component(s) into operation (Iⱼ) may include at least one environmental cost, such as, exergy costs, energy consumption costs, carbon emissions, etc. By way of example, the cost of putting the replacement component(s) into operation, such as to procure the replacement component(s), may include the costs associated with extracting the materials used to fabricate the replacement component(s), costs associated with manufacturing and transporting the replacement component(s), human costs associated with installing the replacement component(s), etc. Moreover, the time period to procure the replacement component(s) (t) may vary depending upon the replacement component(s). For instance, the time period (t) may be relatively short when the replacement component(s) comprises an off-the-shelf server and relatively long when the replacement component(s) comprises a new building or data center.

In addition, the cost associated with disposing the existing component(s) (Dᵢ) may also include environmental costs associated with the disposal of the existing component(s). For instance, these costs may include costs associated with transporting and destroying the existing component(s), which may include costs associated with recycling the existing component(s). Moreover, in instances where the replacement component(s) is determined to have a useful lifetime that is less than the identified length of time that the existing component(s) is determined to have remaining (T) to perform useful work, the cost of disposing the replacement component(s) (Dⱼ) are also included in Equation (6).

Although Equation (6) has been described with the various cost components being added, the various cost components may be multiplied with each other without departing from a scope of the method 200. In addition, the various cost components may be selected as being fixed over time or a time varying value of money may be included in Equation (6).

The new net benefit calculating module 122 is further configured to calculate the new net benefit as a function of the calculated total useful work, the cost of operation, and a fifth weighting coefficient. By way of example, the new net benefit calculating module 116 is configured to calculate the new net benefit (Bⱼ) achievable by operating the replacement component(s) may be evaluated as:

Bⱼ=f(Uⱼ, Cⱼ, W). Equation (7):

By way of particular example, the new net benefit may be determined according to the following equation:

Bⱼ=(Wⱼ₁×Uⱼ)/(Wⱼ₂×Cⱼ). Equation (8):

Although the function in Equation (8) has been described as a quotient, other functions may be applied to determine the new net benefit. For instance, instead of the quotient, a subtraction or multiplication may be applied.

In Equations (7) and (8), W represents a weighting coefficient and may be a single- or multi-dimensional weighting matrix that may be used to bias the net benefit in terms of either utility or cost, depending on, for instance, operational policy. For instance, if performance is determined to be critical, the benefit may be weighted more towards the useful work (Uⱼ); however, if energy efficiency is determined to be critical, the benefit may be weighted more towards the cost (Cⱼ). In addition, or alternatively, the weighting coefficient W may be defined independently, as a function of operating principle, as some function of the previous weighting coefficients (Wⱼ₁, Wⱼ₂), etc. The different components of the weighting coefficient W may also be selected as a unit-dependent set of parameters, for instance, a first weighting coefficient Wⱼ₁ may be a Joules/Performance multiplier and a second weighting coefficient Wⱼ₂ may be a unitless multiplier, thus giving the new net benefit Bⱼ in terms of Joules.

At block 216, a determination as to whether the existing net benefit (Bᵢ) exceeds the new net benefit (Bⱼ) is made, for instance, by the replacement cost estimating module 112. Based upon this determination, the replacement cost estimating module 112 may determine whether to replace the existing component(s) with the replacement component(s) identified at block 208, as indicated at block 218. More particularly, at block 218, the replacement cost estimating module 112 may determine that it will be beneficial to continue to implement the existing component(s) in response to a determination that the existing net benefit (Bᵢ) exceeds the new net benefit (Bⱼ). However, if the replacement cost estimating module 112 determines that the existing net benefit (Bᵢ) falls below the new net benefit (Bⱼ), the replacement cost estimating module 112 may determine that it will be beneficial to replace the existing component(s) with the replacement component(s) at block 218. If the existing net benefit (Bᵢ) equals the new net benefit (Bⱼ), the replacement cost estimating module 112 may determine that either direction is feasible.

In addition, the processor 104 may output the determination made at block 218 to the output 140 as discussed above.

Turning now to FIG. 3, the method 300 may be implemented to enable a determination of whether to replace the existing component(s) based upon an iteration using different lengths of time that the existing component(s) is determined to provide usefulness and how the usefulness is likely to change over time. By way of particular example in which the existing component(s) comprises a server, the change over time may include that a larger number of people are determined to access the server in two years, which changes the utility function of the server.

Based upon these types of assumptions, a model of the useful lifetime of the existing component(s) may be developed, which may be employed to identify the useful lifetime for the existing component(s) that results in an optimized net benefit (Bᵢ). The model may be developed through application of an iterative process that may use a manual or automatic evaluation of various useful lifetimes and changes to the utilities of the existing component(s) over time. By way of example, the iterative process may include an evaluation of the existing component(s) over a period of years, at an increment of 1 year. In addition, simulation techniques may be employed to determine the optimized useful lifetimes (T) of the existing component(s).

The method 300 includes some of the same processes as those discussed above with respect to the method 200. As such, detailed descriptions of those processes having common reference numerals are omitted with respect to the method 300.

Thus, following block 206, at block 302, a determination as to whether the identified useful lifetime (T) determined for the existing component(s) may be changed for further optimality is made, for instance, by the replacement cost estimating module 112. The replacement cost estimating module 112 may make this determination through an iteration of various useful lifetimes and changing utilities over time of the existing component(s), as indicated at block 304 until the replacement cost estimating module 112 identifies a useful determined lifetime (T) for the existing component(s) that results in an optimized net benefit (Bᵢ) of the existing component(s) at block 302. As discussed above, the replacement cost estimating module 112 may develop and implement a model of the existing component(s) over the determined useful lifetime to make this determination. In addition, the replacement cost estimating module 112 may implement simulation techniques to speed up the process involved in making this determination.

If the replacement cost estimating module 112 determines that the determined useful lifetime (T) of the existing component(s) is not further optimizable, the replacement cost estimating module 112 determines that the existing net benefit (Bᵢ) resulting from the optimized determined useful lifetime (T) is identified as the optimized existing net benefit (Bᵢ) for the existing component(s) at block 306. In addition, at block 308, the replacement cost estimating module 112 determines whether a new net benefit (Bⱼ) of a replacement component(s) exceeds the optimized existing net benefit (Bᵢ).

Prior to block 308, however, the replacement cost estimating module 112 may determine the new net benefit (Bⱼ) of a replacement component(s) through, for instance, implementation of blocks 208-214 as shown in FIG. 2. Again, a detailed description of blocks 208-214 is omitted here because these blocks were discussed with respect to FIG. 2.

The replacement component(s) to be considered as a replacement for the existing component(s) may be identified at block 208 based upon the suitability of the replacement component(s) as discussed above. For instance, if the existing component(s) comprises a server, the replacement component(s) identified at block 208 may comprise a number of replacement servers from the same or different manufacturers that are capable of performing at least all of the same functions as the existing component(s). According to an example, the replacement component(s) and information pertaining to the replacement component(s) may be stored in a database and the processor 104 may access the database to identify the suitable replacement component(s) and the cost information pertaining to the suitable replacement component(s).

With reference back to FIG. 3, if the new net benefit (Bⱼ) of the replacement component(s) exceeds the existing net benefit (Bᵢ) of the existing component(s), the processor 104 may output an indication that the existing component(s) is to be replaced with the replacement component(s) identified at block 208 at the time (t) that the replacement component(s) is available, as indicated at block 310. In addition, the replacement component(s) becomes the existing component(s) and another determination of when and whether to replace the replacement component(s) may be determined through another iteration of the method 300.

If, however, the new net benefit (Bⱼ) of the replacement component(s) falls below the existing net benefit (Bᵢ) of the existing component(s), the replacement cost estimating module 112 may determine whether an alternative replacement component(s) is available at block 312. Again, the replacement cost estimating module 112 may access a database containing information pertaining to candidate alternative replacement component(s) to make this determination. In addition or alternatively, the replacement cost estimating module 112 may receive this information from a user.

If, at block 312, the replacement cost estimating module 112 determines that an alternative replacement component(s) is not available, the replacement cost estimating module 112 may output an indication that the existing component(s) is currently optimal and should thus not be replaced, as indicated at block 314. However, if the replacement cost estimating module 112 determines that an alternative replacement component(s) is available, the replacement component(s) identifying module 118 may identify the replacement component(s) at block 208 and may calculate a new net benefit (Bᵢ) of the alternative replacement component(s) at blocks 210-214. In addition, the replacement cost estimating module 112 may again compare the new net benefit (Bj) with the existing net benefit (Bᵢ) at block 308 and may perform certain ones of the processes following block 308 depending upon the comparison. In this regard, the replacement cost estimating module 112 may iterate through alternative sets of replacement components that have been deemed to be suitable replacements for the existing component(s) to identify if there is a suitable alternative replacement component(s) that provides greater benefit than the existing component(s).

In addition, although not explicitly shown in FIG. 3, the replacement cost estimating module 112 may iterate through some or all of the alternative replacement component(s) to identify the alternative replacement component(s) that results in an optimized new net benefit. In this regard, similar to block 302, the replacement cost estimating module 112 may determine an optimized new net benefit for the considered replacement component(s). Again, the replacement cost estimating module 112 may implement simulation techniques to speed up the process in identifying the alternative replacement component(s) that results in the optimized new benefit.

Some or all of the operations set forth in the methods 200 and 300 may be contained as utilities, programs, or subprograms, in any desired computer accessible medium. In addition, the methods 200 and 300 may be embodied by computer programs, which can exist in a variety of forms both active and inactive. For example, they may exist as machine readable instruction(s) comprised of program instructions in source code, object code, executable code or other formats. Any of the above may be embodied on a computer readable storage medium.

Example computer readable storage media include conventional computer system RAM, ROM, EPROM, EEPROM, and magnetic or optical disks or tapes. Concrete examples of the foregoing include distribution of the machine readable instructions on a CD ROM or via Internet download. It is therefore to be understood that any electronic device capable of executing the above-described functions may perform those functions enumerated above.

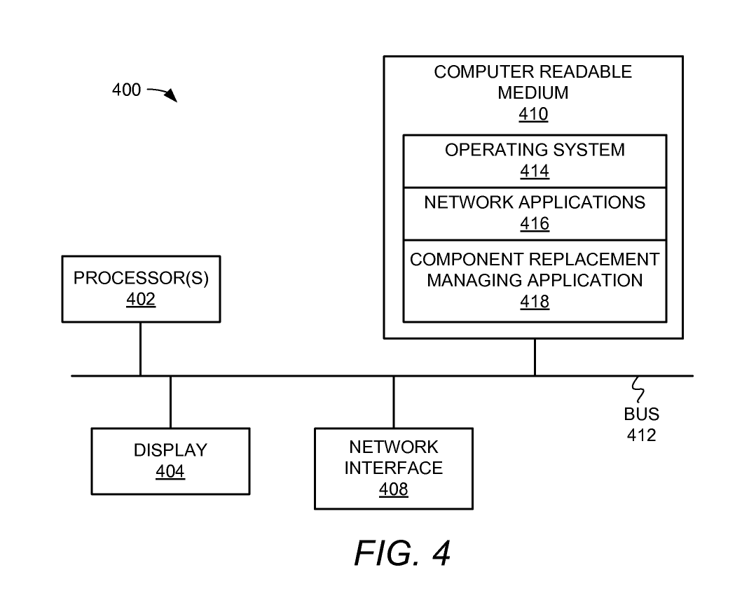

Turning now to FIG. 4, there is shown a schematic representation of a computing device 400 that may be used as a platform for implementing or executing the processes depicted in FIGS. 2 and 3, according an example. The device 400 includes at least one processor 402, such as a central processing unit; at least one display device 404, such as a monitor; at least one network interface 408, such as a Local Area Network LAN, a wireless 802.11x LAN, a 3G mobile WAN or a WiMax WAN; and a computer-readable medium 410. Each of these components is operatively coupled to at least one bus 412. For example, the bus 412 may be an EISA, a PCI, a USB, a FireWire, a NuBus, or a PDS.

The computer readable medium 410 may be any suitable medium that participates in providing instructions to the processor 402 for execution. For example, the computer readable medium 410 may be non-volatile media, such as an optical or a magnetic disk; volatile media, such as memory; and transmission media, such as coaxial cables, copper wire, and fiber optics. Transmission media may also take the form of acoustic, light, or radio frequency waves. The computer readable medium 410 has been depicted as also storing other machine readable instruction applications, including word processors, browsers, email, Instant Messaging, media players, and telephony machine readable instructions.

The computer-readable medium 410 has also been depicted as storing an operating system 414, such as Mac OS, MS Windows, Unix, or Linux; network applications 416; and a component replacement managing application 418. The operating system 414 may be multi-user, multiprocessing, multitasking, multithreading, real-time and the like. The operating system 414 may also perform basic tasks, such as recognizing input from input devices, such as a keyboard or a keypad; sending output to the display 404; keeping track of files and directories on medium 410; controlling peripheral devices, such as disk drives, printers, image capture device; and managing traffic on the at least one bus 412. The network applications 416 include various components for establishing and maintaining network connections, such as machine readable instructions for implementing communication protocols including TCP/IP, HTTP, Ethernet, USB, and FireWire.

The component replacement managing application 418 provides various components with machine readable instructions for providing computing services to users, as described above. In certain examples, some or all of the processes performed by the application 418 may be integrated into the operating system 414. In certain examples, the processes may be at least partially implemented in digital electronic circuitry, or in computer hardware, machine readable instructions (including firmware and/or software) or in any combination thereof.

What has been described and illustrated herein are various examples of the disclosure along with some of their variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method of managing replacement of at least one existing component with at least one replacement component, wherein the at least one replacement component comprises a different number of components than the at least one existing component, said method comprising:
obtaining at least one cost associated with implementing the at least one existing component, wherein the at least one cost includes an environmental cost and a utility cost associated with implementing the at least one existing component;
calculating, with a processor, an existing net benefit of continuing implementation of the at least one existing component based upon the obtained at least one cost; and
calculating a new net benefit of at least one of procuring and implementing the at least one replacement component to replace the at least one existing component.

2. The method according to claim 1, further comprising:
identifying a length of time that the at least one existing component is determined to have remaining to perform useful work and wherein calculating the existing net benefit further comprises calculating a total useful work that the at least one existing component is determined to have remaining in the identified length of time by calculating the total useful work as a function of the identified length of time, the useful work produced by the at least one existing component over a predetermined period of time, and a first weighting coefficient that is selected as a function of operation policy.

3. The method according to claim 2, further comprising:
identifying a direct operational cost of the at least one existing component per unit time; and
wherein calculating the existing net benefit further comprises calculating a cost of operation of the at least one existing component as a function of at least one of the identified length of time, the direct operational cost of the at least one existing component, a second weighting coefficient for cost that is selected as a function of operation policy, the calculated total useful work, the cost of operation of the at least one existing component, and a third weighting coefficient that is selected as a function of operation policy.

4. The method according to claim 3, further comprising:
determining whether the identified length of time that the at least one existing component is determined to have remaining results in an optimized existing net benefit calculation;
in response to a determination that the identified length of time that the at least one existing component is determined to have remaining fails to result in an optimized existing net benefit calculation, performing at least one iteration to identify an optimized length of time that results in the optimized existing net benefit; and
calculating the existing net benefit using the optimized length of time.

5. The method according to claim 4, further comprising:
determining whether the new net benefit exceeds the existing net benefit; and
determining to replace the at least one existing component with the at least one replacement component in response to the new net benefit exceeding the existing net benefit.

6. The method according to claim 5, wherein determining to replace the at least one existing component with the at least one replacement component further comprises determining to replace the at least one existing component with the at least one replacement component at the optimized length of time.

7. The method according to claim 1, further comprising:
determining whether the at least one replacement component results in an optimized new net benefit calculation;
in response to a determination that the at least one replacement component fails to result in an optimized new net benefit calculation, performing at least one iteration to identify an alternative at least one replacement component that results in the optimized new net benefit; and
determining whether the optimized new net benefit exceeds the existing net benefit; and
determining whether to replace the at least one existing component with the alternative at least one replacement component that resulted in the optimized new net benefit based upon the determination of whether the optimized new net benefit exceeds the existing net benefit.

8. The method according to claim 1, further comprising:
identifying an alternative at least one replacement component in response to a determination that an alternative at least one replacement component is available, wherein the alternative at least one component comprises a different number of components than the at least one existing component;
obtaining at least one cost associated with at least one of procuring and implementing the alternative at least one component;
calculating an alternative new net benefit of at least one of procuring and implementing the alternative at least one component based upon the obtained at least one cost;
determining whether the alternative new net benefit exceeds the existing net benefit; and
selecting one of the at least one existing component and the alternative at least one replacement component based upon the whether the alternative new net benefit exceeds the existing net benefit.

9. The method according to claim 1, further comprising:
obtaining at least one cost associated with at least one of procuring and implementing the at least one replacement component, wherein the at least one cost includes at least one of an environmental cost and a utility cost associated with at least one of procuring and implementing the at least one replacement component; and
wherein calculating the new net benefit of at least one of procuring and implementing the at least one replacement component further comprises calculating the new benefit based upon the obtained at least one cost associated with at least one of procuring and implementing the at least one replacement component.

10. The method according to claim 9, further comprising:
identifying a length of time determined to be required in obtaining the at least one replacement component, wherein obtaining the at least one cost further comprises identifying a length of time that the at least one existing component(s) is determined to have remaining to perform useful work, and wherein calculating the new net benefit further comprises calculating a total useful work that the at least one replacement component is determined to have over the identified length of time that the at least one existing component(s) is determined to have remaining to perform the useful work.

11. The method according to claim 10, further comprising:
identifying a cost of implementing the at least one replacement component;
identifying a cost of operation of the at least one replacement component in performing the total useful work;
identifying a disposal cost associated with disposing the at least one existing component; and
wherein calculating the new net benefit further comprises calculating a total cost of at least one procuring and implementing the at least one replacement component as a function of the identified cost of implementing the at least one replacement component, the identified cost of operation of the at least one replacement component in performing the total useful work, the identified disposal cost associated with disposing the at least one existing component, and the length of time that the at least one existing component is determined to have remaining to perform useful work.

12. The method according to claim 1, wherein the at least one existing component comprises at least one existing networking equipment and wherein the at least one replacement component comprises a different number of at least one replacement networking equipment as compared with the at least one existing networking equipment.

13. The method according to claim 12, wherein the at least one replacement networking equipment comprises a plurality of networking equipment to be implemented in a structured topological arrangement with respect to each other.

14. A replacement management apparatus for managing replacement of at least one existing component with at least one replacement component, wherein the at least one replacement component comprises a different number of components than the at least one existing component, said apparatus comprising:
at least one module to obtain at least one cost associated with implementing the at least one existing component, wherein the at least one cost includes an environmental cost and a utility cost associated with implementing the at least one existing component, to calculate an existing net benefit of continuing implementation of the at least one existing component based upon the obtained at least one cost, and to calculate a new net benefit of at least one of procuring and implementing the at least one replacement component to replace the at least one existing component; and
a processor to implement the at least one module.

15. The replacement management apparatus according to claim 14, wherein the at least one module is further to identify a length of time that the at least one existing component is determined to have remaining to perform useful work and to calculate a total useful work that the at least one existing component is determined to have remaining in the identified length of time by calculating the total useful work as a function of the identified length of time, the useful work produced by the at least one existing component over a predetermined period of time, and a first weighting coefficient that is selected as a function of operation policy.

16. The replacement management apparatus according to claim 15, wherein the at least one module is further to identify a direct operational cost of the at least one existing component and to calculate a cost of operation of the at least one existing component as a function of the identified length of time and the direct operational cost of the at least one existing component, and to calculate the existing net benefit as a function of the calculated total useful work and the cost of operation of the at least one existing component.

17. The replacement management apparatus according to claim 14, wherein the at least one cost associated with at least one of procuring and implementing the at least one replacement component includes an environmental cost associated with at least one of procuring and implementing the at least one replacement component,

18. The replacement management apparatus according to claim 14, wherein the at least one module is determine whether the at least one replacement component results in an optimized new net benefit calculation, in response to a determination that the at least one replacement component fails to result in an optimized new net benefit calculation, to perform at least one iteration to identify an alternative at least one replacement component that results in the optimized new net benefit, to determine whether the optimized new net benefit exceeds the existing net benefit, and to determine whether to replace the at least one existing component with the alternative at least one replacement component that resulted in the optimized new net benefit based upon the determination of whether the optimized new net benefit exceeds the existing net benefit.

19. The replacement management apparatus according to claim 14, wherein the at least one existing component comprises at least one existing networking equipment and wherein the at least one replacement component comprises a different number of replacement networking equipment as compared with the at least one existing networking equipment.

20. A computer readable storage medium on which is embedded at least one computer program, said at least one computer program implementing a method of managing replacement of at least one existing component with at least one replacement component, wherein the at least one replacement component comprises a different number of components than the at least one existing component, said at least one computer program comprising a set of instructions to:
obtain at least one cost associated with implementing the at least one existing component, wherein the at least one cost includes an environmental cost and a utility cost associated with implementing the at least one existing component;
calculate an existing net benefit of continuing implementation of the at least one existing component based upon the obtained at least one cost;
calculate a new net benefit of at least one of procuring and implementing the at least one replacement component to replace the at least one existing component;
determine whether the new net benefit exceeds the existing net benefit; and
determine whether to replace the at least one existing component with the at least one replacement component based upon whether the new net benefit exceeds the existing net benefit.
